(19) United States
(12) Patent Application Publication
(10) Pub. No.: US 2009/0293559 A1
(43) Pub. Date: Dec. 3, 2009

(54) CAR LOCK

(76) Inventor: Bing-Huei Jeng, Sinjhuang City (TW)

Correspondence Address: Connolly Bove Lodge & Hutz, LLP, P.O.Box 2207, Wilmington, DE, 19899-2207, US

(21) Appl. No.: 12/128,049

(22) Filed: May 28, 2008

(51) Int. Cl. B60R 25/02

(52) U.S. Cl. 70/209

(57) ABSTRACT

A car lock mainly comprises a steering wheel lock, a stereo lock, a hand brake lock, a first combination connecting mechanism and a second combination connecting mechanism. Whereby, the car lock according to the present invention can effectively prevent a thief from detaching stereo components, operating a steering wheel and hand brake lever to attain to the practical object of effectively preventing a car from being stolen because the whole effective collocation combination may be adopted on every kind of car and provides multiple protections.

### BACKGROUND OF THE INVENTION

1. Field of the Invention

The present invention relates to a car lock, and more particular to a car lock adaptable to every kind of lock capable of providing multiple protections against a burglary effectively so as to prevent a car and an inner stereo thereof from being stolen.

2. Description of Related Art

There are many kinds of car locks, common ones among them are gear shift lock, steering wheel lock and etc., however, a conventional lock is not perfect no matter what kind of structure it is; the main defect thereof is that it is unable to protect a car stereo from being stolen.

### SUMMARY OF THE INVENTION

For improving a car lock structure, the present invention is proposed.

The main object of the present invention is to provide a car lock, adaptable to every kind of car and capable of providing multiple protections to check a stealing effectively to attain to the burglarproof effect of preventing a car and an inner stereo thereof form being stolen.

For attaining to the object mentioned above, the present invention discloses a car lock, mainly comprises:
a steering wheel lock, provided with a extensible stick capable of multistage positioning with a lock head,
hooping hooks being respectively disposed under two ends of the extensible stick capable of being clipped on a steering wheel while being extended;
a stereo lock, comprising upper and lower cover plates pivotally coupled to each other with a lock head, a rear face of the upper cover plate being provided with an insertion rod used for inserting in and fixing on an vented hole, and the lower cover plate being used for covering a whole stereo panel;
a hand brake lock, being an extensible stick with a lock head capable of multistage positioning, a hand brake sleeve being pivotally coupled under the extensible stick,
a propping plate capable of pressing down a hand brake lever to prevent the hand brake lever from being pulled when the extensible stick is extended being installed in the sleeve;
a first combination connecting mechanism, installed between the steering wheel lock and the stereo lock; and a second combination coupling mechanism, installed between the stereo lock and the hand brake lever to enforce the protection;
whereby, a thief is not allowed to detach stereo components, unable to operate the steering wheel and hand brake lever to effectively prevent a car from being stolen.

### BRIEF DESCRIPTION OF THE DRAWINGS

The present invention can be more fully understood by reference to the following description and accompanying drawings, in which:

FIG. 1 is a schematic view of a car lock according to the present invention in practice;

FIG. 2 is an exploded view, showing a steering wheel according to the present invention;

FIG. 3 is a partly cross sectional view, showing a locking motion of a clipping mechanism according to the present invention;

FIG. 4 is a partly cross sectional view, showing a releasing motion of a clipping mechanism according to the present invention;

FIG. 5 is a partly cross sectional view, showing a structure capable of clipping on and protecting one side of a steering wheel according to the present invention;

FIG. 6 is a perspective view, showing a first combination connecting mechanism according to the present invention; FIG. 7 is an exploded view, showing a stereo lock according to the present invention;

FIG. 8 is a perspective view, showing a volume reducible stereo lock according to the present invention after being folded;

FIG. 9 is a schematic view, showing a disk pressing grip and rotating stick coupled to each other according to the present invention; and

FIG. 10 is an exploded view, showing a hand brake lock according to the present invention.

### DETAILED DESCRIPTION OF THE PREFERRED EMBODIMENTS

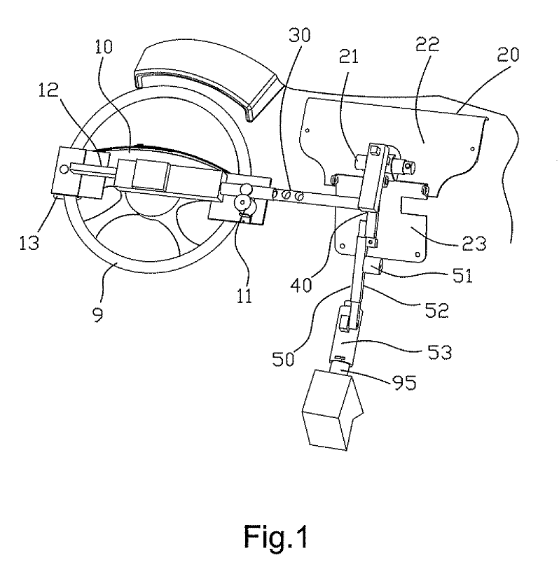

Please refer to FIG. 1. A car lock according to the present invention mainly comprises a steering wheel lock 10, a stereo lock 20 and a first combination connecting mechanism 30.

The steering wheel lock 10 is a extensible stick 12 with a lock head 11 and capable of multistage positioning, two ends of is disposed with hooping hooks 13 to allow it to be clipped on a steering wheel 9 when the extensible stick 12 is extended.

The stereo lock 20 comprises upper and lower cover plates 22 and 23 pivotally coupled to each other provided with a lock head 21, a rear face of the upper cover plate 22 is disposed with an insertion rod 24 used for inserting in air inlet of a car air conditioner, and the lower cover plate 23 may cover a whole stereo panel.

The first combination connecting mechanism 30 is installed between the steering wheel lock 10 and the stereo lock 20.

Furthermore, a second combination connecting mechanism 40 may further installed on the stereo lock 20 and a hand brake lock 50 is connected onto a rear side thereof comprising a multistage positioning extensible stick 52 with a lock head 51, a bottom of the extensible stick 52 is pivotally connected to a hand brake sleeve 53 in which a propping plate 532 is disposed used for compressing the hand-brake lever 95 to prevent it from being released when the extensible stick 52 is extended.

Whereby, a thief is unable to detach stereo components and operate a steering wheel and hand-brake lever so as to prevent a car from being stolen because the whole can be effectively arranged in groups and combined.

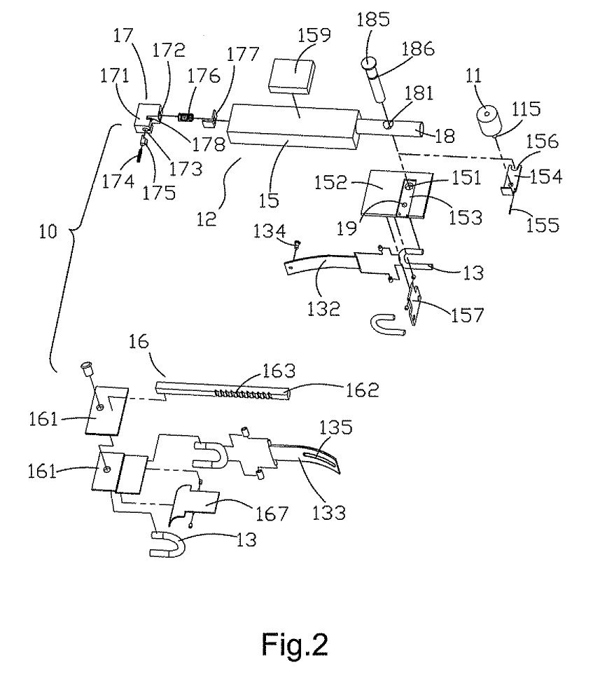

Please refer to FIG. 2. The steering wheel lock 10 may comprises a metal base 15, a connecting plate 152 and a combination shaft 16.

The metal base 15 is a flat rectangular hollow tube, a clipping mechanism 17 is installed inside it; one side of the metal base 15 is installed with a connecting tube 18, and a through hole 181 is disposed on the connecting tube 18 used for inserting a locking insertion rod 185 which is a trapezoid column; a cannelure 186 is disposed on a part of the column with a small diameter.

The connecting plate 152 is directly disposed under the metal base 15, in which a oscillating plate 157 is pivotally coupled to a lower side of the connecting plate 152, and two hooping hooks 13 are fixed on two sides thereof; two holes are disposed on a lower side of the oscillating plate 157 for allowing the oscillating plate 157 to be engaged with the hooping hooks 13. Furthermore, a through hole 151 for allowing the locking inserting rod 185 to be inserted therein is disposed on the connecting plate 152, a groove 153 for allowing a L-typed hooping plate 154 to be disposed thereon is formed outside the hole 151, and a spring 155 is installed between the hooping plate 154 and the connecting plate 152 to allow them to hook and pull each other. A front side of the hooping plate 154 is disposed with a circular notch 156. Corresponding places of the L-typed hooping plate 154 and the connecting plate 152 are respectively disposed with a hole 19 for allowing a locking head 11 which is a push-in lock to be installed thereon. A locking bolt 115 will be projected out to insert into the locking hole 19 to cause the L-typed hooping plate 154 to be limited to pinch during a locking.

The combination shaft 16 is formed by two stacked plate bodies coupled to each other, in which a lower one of the plate bodies 161 is allowed to be oscillated; a extended-out positioning bolt 162 is disposed on the plate body 16; row teeth for providing a multistage positioning is disposed on the positioning bolt 162; a buckling plate 167 id pivotally coupled to a lower side of the plate body 161 and two hooping hooks are respectively fixed on two sides thereof.

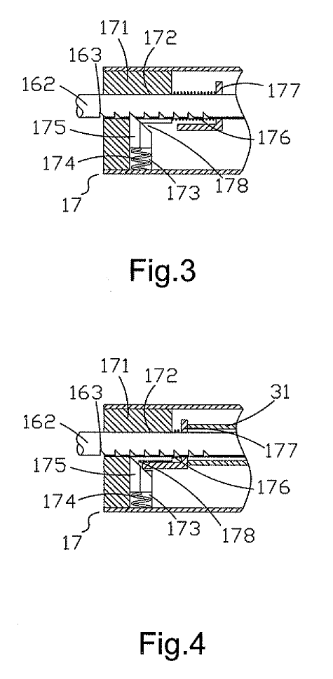

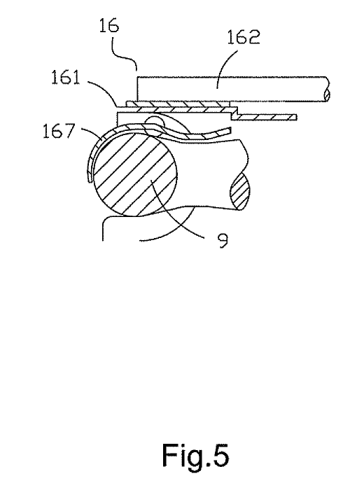

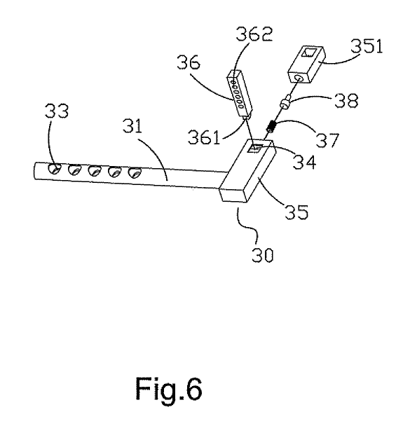

Please refer to FIGS. 1 to 5. The positioning bolt 162 and the metal base 15 are oppositely inserted into each other to form the aforesaid extensible stick 12 during the assembly, and the clipping mechanism 17 is provided with a L-typed sliding base 171, in which the sliding base 171 is passed through from the front to the rear thereof to allow the positioning bolt 16 of the combination shaft 16 to be inserted therein. One side of a slide 172 is disposed with a through hole 173 inside which a spring 174 and a wedged tenon 175 is filled to allow the positioning bolt 162 to be moved forward in a single direction to clip and retain onto the clipping mechanism 17 at multistage ctuben positions while being drawn out to enable the hooping hook 13 respectively disposed under two ends thereof to be clipped on a steering wheel 9 while being lengthened and in the meantime, propped against the oscillating plate 157 and the buckling plate 167 to allow it to be naturally rotated to cover the steering wheel 9 completely to cause a thief difficult to start damaging the lock laterally even by a saw.

Besides, a spring 176 and a L-typed elastic plate 177 are installed on a rear side of the slide 172; a long side of the L-typed elastic plate 177 may be used to insert into a base gap 175 of to poke the tenon 178 away to allow the positioning bolt 162 to be released when the L-typed elastic plate 177 is pressed and the steering wheel lock 10 can then be detached.

Please refer to FIGS. 1, 2 and 5. Collars 131 may used for respectively pivotally coupling to inner and outer protection plates 132 and 133 may also respectively disposed on rear sides of the hooping hooks 13 respectively close to upper positions of two sides of the metal base 15 and the combination stick 16 according to the present invention, in which a positioning screw 134 and an extensible slot 135 may respectively disposed on the two protection plates 132 and 133 to allow the lock to further buckle and protect a upper side of the steering wheel 9 to cause a thief to be unable to damage the lock from the upper side. Moreover, a space used for installing an electronic burglar alarm 159 may also be disposed on the metal base 15 to allow an alarm to be emitted while being touched so as to further elevate the protection function of the steering wheel 10 so as to attain to the intimidation effect.

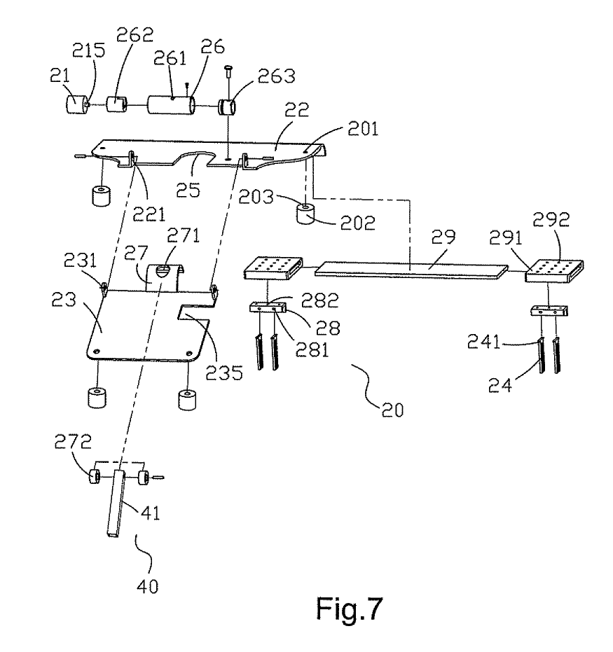

Please refer to FIGS. 1 and 6. The first combination connecting mechanism 30 has a grasping compressing stick in which one end thereof is a hollow inner tube used for inserting in the connecting tube 18, row holes used for providing the aforementioned locking insertion rod with a position selecting insertion are disposed on the hollow inner tube. Meanwhile, an outer circumference of the locking insertion rod 185 appropriately compresses one side of the oscillating plate 157. Another side of the tube is projected with a grip seat 35, a through hole 34 used for allowing a disk pressing grip 36 to be inserted therein is disposed on a upper side of the seat 35, in which a front end of the disk pressing grip 36 is disposed with a front hole sheet 361 with a smaller diameter and a rear section thereof is provided with row holes 362. Furthermore, an inner hole snare 351, a spring 37 and a check pin 38 are correspondingly disposed in the seat to allow the disk pressing grip 36 merely to be moved forward and unable to be moved backward while being placed in so as to press the stereo lock 20 effectively.

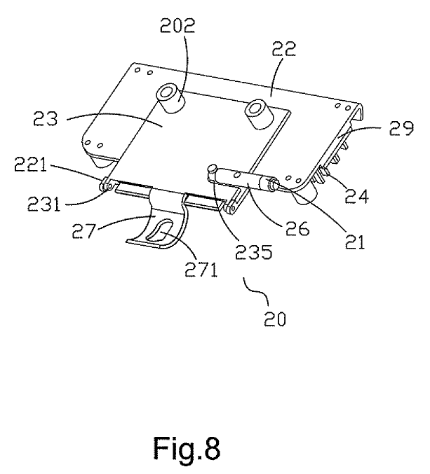

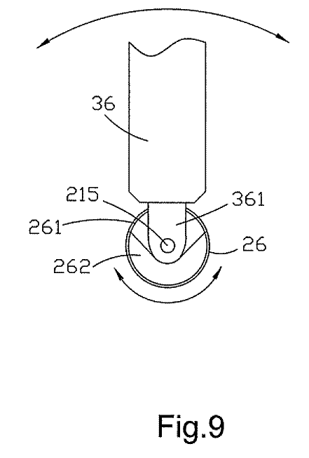

Please refer to FIGS. 1, 7, 8 and 9. The upper cover plate 22 is convex, two sides of a front end thereof are respectively disposed with a pivotally coupling hole sheet 221, a notch 25 is disposed between them, a rotating stick 26 is pivotally coupled onto one side of the notch 25, in which the rotating stick 26 is a hollow circular column, a elliptic grip insertion opening 261 is disposed thereon, and a positioning notch seat 262 in which one side thereof is movably locked to a groove gripping seat 263 and another side thereof is disposed with the aforementioned lock head 21 is correspondingly disposed on an inner side of rotating stick 26; the lock head 21 is a push-in lock, the locking bolt 215 thereof will be projected out while locking is processed to pass through into the notch seat 262 to be combined with it to lock the front hole sheet 361 of the inserted-in disk pressing grip 36 to allow it to be positioned.

Furthermore, a rear side of the upper cover plate 22 is disposed with a track plate 29 used for allowing a plurality of sliding seats 291 to be put around, in which matrix distribution locking holes 292 are disposed on each sliding seat 291 used for enabling a vented positioning mass 28 with a bottom hole 282 to be locked on a selected position thereof, in which the vented positioning mass 28 is a U-typed sheet in which two sides thereof are respectively disposed with a side hole 281 to allow the plurality of insertion rods 24 to be mounted thereon, in which the insertion rod 24 is a comb type, two sides of a tail end thereof are respectively disposed with a flange 241 to allow the side holes 281 to be taken as a center to lift and oscillate after being combined with the vented positioning mass 28; the insertion rods 24 may be extended out to insert into an air vent while being used and folded to collect together to decrease a storage height while being collected to store.

Furthermore, the lower cover plate 23 is a rectangular plate, two sides thereof are respectively disposed with a pivotal hole sheet 231 to pivotally couple to the upper cover plate 22, a middle part thereof is projected with a curved sheet 27, and a larger elliptic insertion opening 271 corresponding to the rotating stick 26 is disposed on the sheet 27; the rotating stick 26 is rotated to a fixed position in practice, the curved sheet 27 is rotated to lean against a upper side thereof closely to allow the insertion openings 261 and 271 of the both to be face to face so as to enable the front hole sheet 361 of the disk pressing grip to be inserted smoothly. Furthermore, one side of the lower cover plate 23 may be disposed with a breach 235 to allow the rotating stick 26 to be appropriately dodged to enable the upper and lower plates 22 and 23 to be attached onto each other to reduce the storage volume when the upper and lower cover plates 22 and 23 are folded together after the stereo lock 20 is detached.

Besides, rear faces of the upper and lower cover plates 22 and 23 may be respectively disposed with a plurality of locking holes 201 to allow locking degrees of a plurality of elastic adjusting knob 202 to be adjusted dynamically; the elastic adjusting knob 202 is a circular column and a material thereof is an elastic material, a center thereof is a spot-faced hole 203 for allowing a screw to be passed through to lock to allow the stereo lock 20 to be cushioned sufficiently to prevent a surface of each part of a vehicle from being scratched in practice.

Besides, a projecting ring 272 may be installed on each one of two sides of a inclined face of the curved sheet 27, and a inserting stick 41 is pivotally coupled between the two projecting rings 272 to be as the second combination connecting mechanism 40 mentioned above and used for connecting with a hand brake lock 50 stated thereinafter.

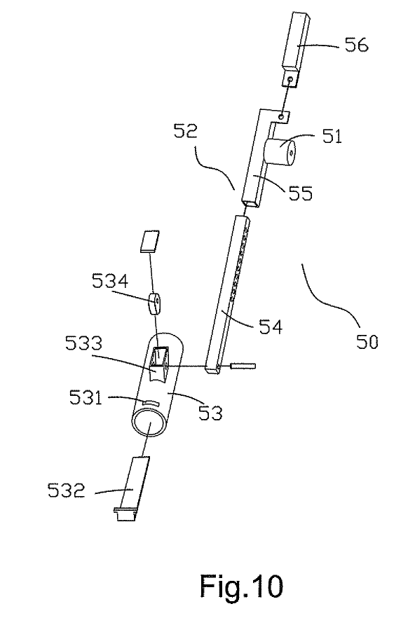

Please refer to FIGS. 1 and 10. A rectangular groove 531 is disposed on a position close to an opening of the had brake sleeve 53 of the hand brake lock 50 to allow a L-typed propping plate 532 to be hung in the sleeve 53; a space 533 with a hole is projected on a middle part of the sleeve 53 to allow an eccentric cam 534 to be mounted therein.

The extensible stick 52 is provided with an outer sleeve 55 and an inner stick 54 with row holes disposed thereon, in which a upper side of the inner stick 54 can be adjusted to a proper limit length, a lower side thereof is then connected to the eccentric cam 534 and linked up therewith; a aforementioned lock head is installed on one side of the outer sleeve 55; the lock head is also a push-in type, a lock bolt (not shown in the figure) can be projected out to insert into the inner stick 54 to lock it while being pressed. Besides, a rotatable outer tube connecting head 56 is pivotally coupled onto a front side of the outer sleeve 55 to connect to the insertion stick 41.

Whereby, a lock of the present invention can be assembled on a car body in practice as the following steps as FIGS. 1 to 10 show:
1. mounting first the steering wheel lock 10 on a proper position, pulling the positioning bolt 162 and the extensible stick 12 constructed by the metal base 15 to allow them to be extended relatively, clipping the steering wheel 9 with the hooks 13 disposed on two sides of the bottom, propping against the oscillating plate 157 and the buckling plate 167 to allow them to be rotated naturally to cover the steering wheel 9 to cause a thief to be difficult to damage the lock from one side thereof. Meanwhile, the upper side of the steering wheel 9 can be buckled and protected more effectively to cause a thief to be unable to damage the lock from the above by pivotally coupling the inner and outer protection plate 132 and 133 provided with the screw 131 and the extensible slot 135 to a position close to the rear side of the upper hooping hook 13.
2. opening the upper and lower cover plates 22 and 23 of the stereo lock 20 to allow the rotating stick 26 to an anchor position, rotating the curved sheet 27 to prop against the rotating stick 26 closely to cause the insertion openings 261 and 271 of the both to face each other, and extending the insertion rod 24 on the rear side of the upper cover plate 22 out to aim at vented hole and insert therein to enable the lower cover plate to cover a whole stereo panel, in which that a plurality of elastic adjusting knobs 202 may be installed on the rear face of the upper and lower cover plates 22 and 23 may be used to allow the stereo lock 20 to be cushioned sufficiently and a surface of each part of the car to be prevented from being scratched in practice during assembly.
3. mounting the hand brake sleeve 53 of the hand brake lock 50 on a proper position of the hand brake lever 95, rotating the extensible stick 52 and the outer tube connecting head 56 to adjust it to a position to allow the insertion stick 41 of the second combination connecting mechanism 40 to be connected with the outer tube connecting head 56, pressing the lock head 51 down to lock the inner stick 54 with row holes to cause the eccentric cam 534 at another end of the extended inner stick 24 to be rotated to prop against the L-typed propping plate 532 in the sleeve 53 to press the hand brake lever 95 accurately to avoid being pulled.
4. inserting the grasping compressing stick 31 of the first combination connecting mechanism 30 into the connecting tube 18 of the metal base 15, positioning the grasping compressing stick 31 by inserting the locking insertion stick 185, pinching the L-typed hooping plate 154 tightly to limit the locking insertion stick 185 and using the locking head 11 to lock one side of lock the L-typed hooping plate.

Wherein, the most important is that the grip seat 35 must be extended accurately and without any error to the upper side of the stereo lock 20 while executing the aforementioned Step 4, the disk pressing bolt 36 can only be moved forward to project into the through hole 34 via the aforementioned insertion openings 261 and 271, and finally prop against the positioning notch seat 262 of the rotating stick 26 after the disk pressing grip 36 is inserted in the through hole 34. Moreover, the lock head is pressed down to allow the locking bolt thereof to be projected out to penetrate into and couple to the front hole sheet of the disk pressing bolt 36 to lock and limit the lock head 26.

Whereby, a car lock according to the present invention can effectively prevent a thief from detaching stereo components, operating a steering wheel and hand brake lever to attain to the practical object of effectively preventing a car from being stolen because the whole effective collocation combination may be adopted on every kind of car and provides multiple protections such as steering wheel lock, electronic burglar alarm, stereo lock and hand brake alarm.

Furthermore, a user only needs to undo the locks 21, 31, 51 and etc. one by one while wanting to detach a car lock according to the present invention, and he may then unload the first combination connecting mechanism 30, the second combination connecting mechanism 40, the steering lock 10, the stereo lock 20, the hand brake lock 50 and etc. one by one; the detaching operation is not difficult; it is only a reverse operation of the aforementioned assembly steps, the details thereof is omitted here.

However, it is necessary to state here that because the disk pressing grip 30 of the present invention can only be moved forward in a single direction and is unable to be moved backward after being mounted in, the locking insertion stick 185 must be pulled out while being detached, the grasping compressing stick 31 is rotated, and a design of the relatively rotatable rotating stick is then operated in coordination to allow the front hole sheet 31 of the disk pressing grip 30 to be withdrawn automatically after being rotated with an angle; the stereo lock 30 can be taken down naturally and the disk pressing grip 36 may also be extended forward again to insert into the whole stereo lock 20 and then take it out. Thereafter, only if a hollow inner tube of the grasping compressing stick 31 is pushed into the connecting tube 18, it will finally prop against the L-typed elastic plate 177 to allow a long side thereof to be inserted into the base gap 178 to poke the tennon 175 away to cause the positioning bolt 162 to be released, and the steering wheel can then be unloaded.

Additional advantages and modifications will readily occur to tube skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A car lock, comprising:
a steering wheel lock, being an extensible stick with a lock head capable of multistage positioning, hooping hooks being disposed under two ends of said extensible stick to allow said extensible stick to be clipped on a steering wheel while being extended;
a stereo lock, being upper and lower cover plates pivotally coupled to each other provided with a lock head, a rear face of said upper cover plate is disposed with an insertion rod to allow said upper cover plate to be inserted in a vented hole, and said lower cover plate being used for covering a whole stereo panel; and
a first combination connecting mechanism, installed between said steering lock and said stereo lock;
whereby, said car lock causes a thief to be unable to detach stereo components and operate said steering wheel to effectively prevent a car from being stolen.

2. The car lock according to claim 1, wherein a second combination connecting mechanism is further installed on said stereo lock, a rear side thereof being connected to a hand brake lock, said hand brake lock being an extensible stick with a lock head capable of multistage positioning, a hand brake sleeve being pivotally coupled under said extensible stick, a propping plate being installed in said sleeve to allow a hand brake to be pressed to prevent said hand brake from being pulled when said extensible stick is lengthened.

3. The car lock according to claim 1, wherein said steering wheel lock comprises:
a metal base, being a square and flat hollow tube, a clipping mechanism is installed therein, a connecting tube being disposed on one side of said metal base, a through hole used for allowing a locking insertion stick to be inserted therein, being disposed on said connecting tube, said locking insertion stick being a ladder-typed column, a place of said column being disposed with a cannelure;
a connecting plate, connected to a place below said metal base, a oscillating plate being pivotally disposed below said connecting plate, said oscillating plate being disposed with two holes used for allowing said oscillating plate to be engaged with hooping hooks, two sides thereof being fixed with said two hooping hooks, and a through hole used for allowing said locking insertion stick to be inserted therein being disposed on said plate, a groove used for being installed with a L-typed hooping plate being formed outside said hole, a spring being disposed between said L-typed hooping plate and said connecting plate to allow said L-typed hooping plate and said connecting plate to pull each other close, a circular concave hooping opening being disposed in front of said connecting plate, a locking hole being disposed on corresponding positions of said L-typed hooping plate and said connecting plate to allow said lock head to be installed therein; and
a combination stick, being two plates pivotally folded to each other, said lower plate being allowed to oscillate, an extended-out positioning bolt being disposed on said plate, row teeth used for allowing multistage positioning being disposed on said bolt, and a movable clipping plate being pivotally coupled under said plate, two sides thereof being fixed with two said hooping hooks;
whereby, said positioning bolt is inserted in said hollow tube of said metal base to combine into said extensible stick, and formed with said clipping mechanism a mutual engagement and fixation of a single directional proceeding and multistage positioning to allow said hooping hooks, said oscillating plate and said movable clipping plate to buckle and protect a steering wheel.

4. The car lock according to claim 3, wherein said clipping mechanism has a L-typed slide base, front and rear sides thereof are passed through to allow said positioning bolt of said combination stick to be inserted therein, a through hole is disposed on one side of a slide to allow a spring and a wedged tenon to be filled therein, a spring and a L-typed elastic plate, a long side thereof is inserted into a base gap to poke away and release said tenon while being pressed.

5. The car lock according to claim 3, wherein said metal base is disposed with a space for accepting an electronic burglar alarm; collars used for pivotally coupling to inner and outer protection plates are installed on said upper hooks on two sides of said metal base and combination stick, a positioning screw and extensible slot are respectively disposed on said inner and outer protection plates so as to strengthen the protection of a upper side of said steering wheel.

6. The car lock according to claim 1, wherein said first combination connecting mechanism is provided with a grasping compressing stick, one end thereof is disposed with a hollow inner tube used for inserting in a connecting tube of said metal base, row holes are disposed on said inner tube to allow said locking insertion stick to be positioned to insert therein, one side of said inner tube is disposed with a grip seat, a upper side of said seat is disposed with a through hole for allowing a disk pressing grip to be inserted therein, s front hole sheet with a smaller diameter is disposed on a front end of said disk pressing grip, a rear section thereof is disposed with row holes, an inner hole snare, a spring and check pin are respectively installed in said seat to cause said disk pressing grip to be moved only in one single direction and unable to be moved rearward so as to prop against said stereo lock effectively.

7. The car lock according to claim 1, wherein said cover plate of said stereo lock is convex, two sides of a front end thereof are respectively disposed with a pivoting hole sheet, a middle position thereof is disposed a notch, a rotating stick is pivotally coupled onto one side of said groove; said lower cover plate is a rectangular plate, two sides thereon are respectively disposed with a pivoting hole sheet pivotally coupled to said upper cover plate, a middle part thereof is projected with a curved sheet, an insertion opening corresponding to said rotating stick is disposed on said sheet, a breach is disposed on one side of said lower cover plate to allow said upper and lower plate to dodge said rotating stick to enable said upper and lower plates to attach to each other so as to reduce a storage volume when said upper and lower cover plates are folded together after said stereo lock is detached down.

8. The car lock according to claim 7, wherein said rotating stick is a circular hollow column, a upper side thereof is disposed with an elliptic grip insertion opening, and an inner part thereof is correspondingly disposed with a positioning notch seat, one side thereof is movably locked with a groove gripping seat, and another side thereof is disposed with a push-in lock, said locking bolt of said lock will be projected out and extended during locking to penetrate in and coupled to a front hole of said disk grip in said notch seat to lock and limit.

9. The car lock according to claim 6, wherein said rotating stick is a circular hollow column, a upper side thereof is disposed with an elliptic grip insertion opening, and an inner part thereof is correspondingly disposed with a positioning notch seat, one side thereof is movably locked with a groove gripping seat, and another side thereof is disposed with a push-in lock, said locking bolt of said lock will be projected out and extended during locking to penetrate in and coupled to a front hole of said disk grip in said notch seat to lock and limit.

10. The car lock according to claim 7, wherein rear faces of said upper and lower cover plates are respectively disposed with a plurality of locking holes used for allowing elastic adjusting knob to adjust a locking dynamically; said elastic adjusting knob is a circular column, a material thereof is resilient, a center thereof is disposed with a spot-faced hole for allowing a screw to be passed through to lock; a back face of said upper cover plate is disposed with a track plate for allowing a plurality of sliding seats to be engaged therewith, the plurality of insertion rods are pivotally coupled onto each said sliding seat, said insertion rod is a foldable comb-like body.

11. The car lock according to claim 7, wherein two sides of a inclined face of a curved sheet of said lower cover plate are respectively disposed with a projecting ring, an insertion stick is pivotally coupled to a middle part thereof to use as said second combination connecting mechanism; a place close to an opening of said hand brake sleeve is disposed with a rectangular groove to allow a L-typed propping plate to be hung in said sleeve, a middle place of a sleeve body corresponding thereto is projected with an accepting space with a hole used for mounting an eccentric cam therein; said extensible stick has an outer sleeve and an inner stick with row holes inserted therein, wherein, a limit length of a upper side of said inner stick is allowed to be adjusted properly, a lower side thereof is connected to said eccentric cam closely and moved therewith; said lock head is installed on one side of said outer sleeve to allow a locking bolt to be projected and insert in said outer sleeve to lock said inner stick, an inner tube connection head capable of being rotated is further pivotally coupled to a front side of said outer sleeve used for allowing said insertion stick to be inserted therein.

12. The car lock according to claim 2, wherein two sides of a inclined face of a curved sheet of said lower cover plate are respectively disposed with a projecting ring, an insertion stick is pivotally coupled to a middle part thereof to use as said second combination connecting mechanism; a place close to an opening of said hand brake sleeve is disposed with a rectangular groove to allow a L-typed propping plate to be hung in said sleeve, a middle place of a sleeve body corresponding thereto is projected with an accepting space with a hole used for mounting an eccentric cam therein; said extensible stick has an outer sleeve and an inner stick with row holes inserted therein, wherein, a limit length of a upper side of said inner stick is allowed to be adjusted properly, a lower side thereof is connected to said eccentric cam closely and moved therewith; said lock head is installed on one side of said outer sleeve to allow a locking bolt to be projected and insert in said outer sleeve to lock said inner stick, an inner tube connection head capable of being rotated is further pivotally coupled to a front side of said outer sleeve used for allowing said insertion stick to be inserted therein.
